(19) United States
(12) Patent Application Publication
(10) Pub. No.: US 2012/0133579 A1
(43) Pub. Date: May 31, 2012

(54) GESTURE RECOGNITION MANAGEMENT

(75) Inventors: Jean-Marc Prieur, Ollioules (FR); Stuart Kent, Canterbury (GB); Duncan Pocklington, Cambridge (GB); Blair McGlashan, Biggleswade (GB); Eyal Lantzman, Cambridge (GB); Christopher J. Lovett, Woodinville, WA (US)

(73) Assignee: Microsoft Corporation, Redmond, WA (US)

(21) Appl. No.: 12/955,937

(22) Filed: Nov. 30, 2010

(51) Int. Cl. G09G 5/00

(52) U.S. Cl. 345/156

(57) ABSTRACT

A system and method for managing the recognition and processing of gestures. A system provides a mechanism to detect conflicts between gesture recognizers and resolve the conflicts. A runtime system receives notifications from gesture recognizers in the form of requests for resources or actions. A conflict detector determines whether a conflict with another gesture recognizer exists. If a conflict exists, a conflict resolver determines a resolution. This may include determining a winning gesture recognizer and deactivating the losing gesture recognizers. A design time system statically validates gesture recognizers based on static state machines corresponding to each gesture recognizer.

### BACKGROUND

When interacting with a computer system, a user may employ various gestures to enter commands, respond to events, or perform various actions. A gesture typically includes one or more input events in a designated order. Input events may include input such as pressing a mouse or keyboard button, moving a mouse, dragging a finger on a touchpad or touchscreen, lifting a finger from a touchpad or touchscreen, or the like. A gesture may be used to indicate a command to the computer system. A diagramming object movement is an example of an action designated by a gesture. A gesture that includes using a mouse to click down on a rectangle, dragging the mouse, and releasing the mouse button may indicate a command to move the rectangle.

A computer system may use a number of gestures. Some gestures may overlap with respect to the input events, such that during execution of a gesture, there may be ambiguity as to what gesture is being performed. In some cases, even upon completion of one or more input events, there may be ambiguity as to which gesture was performed. Software that interprets and handles gestures may come from different entities, or may be added to a computer system at different times. This adds complexity to the task of recognizing and handling gestures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, in one embodiment, a system, method, and components operate to facilitate recognition and processing of gestures. This may include detecting conflicts among two or more gesture recognizers at runtime, determining a way to resolve the conflict, and facilitating resolution of a conflict based on the determination.

In one embodiment, mechanisms include receiving from a gesture recognizer a notification that the gesture recognizer has recognized, or at least partially recognized, a gesture based on a current input event or event stream, and determining whether a conflict exists by determining whether any other gesture recognizers have at least partially recognized another gesture based on the input event. If a conflict exists, mechanisms may include actions to resolve the conflict, such as determining a winning gesture recognizer from among those that at least partially recognize a gesture and enabling the winning gesture recognizer to proceed with its gesture processing. In one embodiment, enabling the winning gesture may include deactivating one or more other gesture recognizers that conflict.

In one embodiment, receiving a notification may include receiving a request to access a resource, such as a cursor, or to perform an action.

In one embodiment, one or more gesture recognizers may have a corresponding state machine, and conflict detection actions use the one or more state machines to determine a conflict.

In one embodiment, at least one of the gesture recognizers has a corresponding state machine, and a static validation is performed based on the state machines. This may include detecting conflicts between state machines, internal logic problems related to a state machine, or other indications of invalidity.

In one embodiment, management of conflicting gestures may include detecting a conflict and enabling a user to select a resolution of the conflict. The resolution may apply to the current conflict or to similar conflicts that occur in the future.

To the accomplishment of the foregoing and related ends, certain illustrative aspects of the system are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram of an example computer system in which mechanisms described herein may be deployed;

FIG. 2 is a block diagram of an example computer system in which conflicts among gesture recognizers may be statically analyzed;

FIG. 3 is a block diagram of an example computer system in which gesture recognizers may be managed during runtime;

FIG. 4 is a block diagram illustrating an example state machine that may be used to implement a gesture recognizer in accordance with mechanisms described herein;

FIG. 5 is a flow diagram illustrating an example embodiment of a process for performing a static validation of a gesture recognizer;

FIG. 6 is a flow diagram illustrating an example embodiment of a process for managing gesture recognizers during runtime;

FIG. 7 is a flow diagram illustrating an example embodiment of a process for initializing a gesture management system;

FIG. 8 is a flow diagram illustrating an example embodiment of a process for handling gesture conflicts during runtime; and

FIG. 9 is a block diagram showing one embodiment of a computing device, illustrating selected components of a computing device that may be used to perform functions described herein.

### DETAILED DESCRIPTION

Example embodiments of the present invention now will be described more fully hereinafter with reference to the accompanying drawings, which form a part hereof, and which show, by way of illustration, specific example embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to a previous embodiment, though it may. Furthermore, the phrase “in another embodiment” as used herein does not necessarily refer to a different embodiment, although it may. Thus, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “processor” refers to a physical component such as an integrated circuit that may include integrated logic to perform actions.

As used herein, the term “application” refers to a computer program or a portion thereof, and may include associated data. An application may be an independent program, or it may be designed to provide one or more features to another application. An “add-in” and a “plug-in” are examples of applications that interact with and provides features to a “host” application.

An application is made up of any combination of application components, which may include program instructions, data, text, object code, images or other media, security certificates, scripts, or other software components that may be installed on a computing device to enable the device to perform desired functions. Application components may exist in the form of files, libraries, pages, binary blocks, or streams of data. An application component may be implemented as a combination of physical circuitry and associated logic. For example, an ASIC may be used to implement an application component.

The components described herein may execute from various computer-readable media having various data structures thereon. The components may communicate via local or remote processes such as in accordance with a signal having one or more data packets (e.g. data from one component interacting with another component in a local system, distributed system, or across a network such as the Internet with other systems via the signal). Software components may be stored, for example, on non-transitory computer-readable storage media including, but not limited to, an application specific integrated circuit (ASIC), compact disk (CD), digital versatile disk (DVD), random access memory (RAM), read only memory (ROM), floppy disk, hard disk, electrically erasable programmable read only memory (EEPROM), flash memory, or a memory stick in accordance with embodiments of the present invention.

The term computer-readable media as used herein includes both non-transitory storage media and communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media.

Briefly, in one embodiment, mechanisms described herein may be used to manage gestures and applications that process gestures. This management may include validating logic of gesture recognizers during a design time phase of application development. Management may include detecting conflicts between two or more gesture recognizers during program execution, determining a way to resolve the conflict, and facilitating resolution of a conflict based on the determination. In one embodiment, determining a way to resolve a conflict may include determining a “winning” gesture recognizer to process the gesture, enabling the determined gesture recognizer to proceed, and notifying other gesture recognizers that they are to discontinue processing of the current gesture.

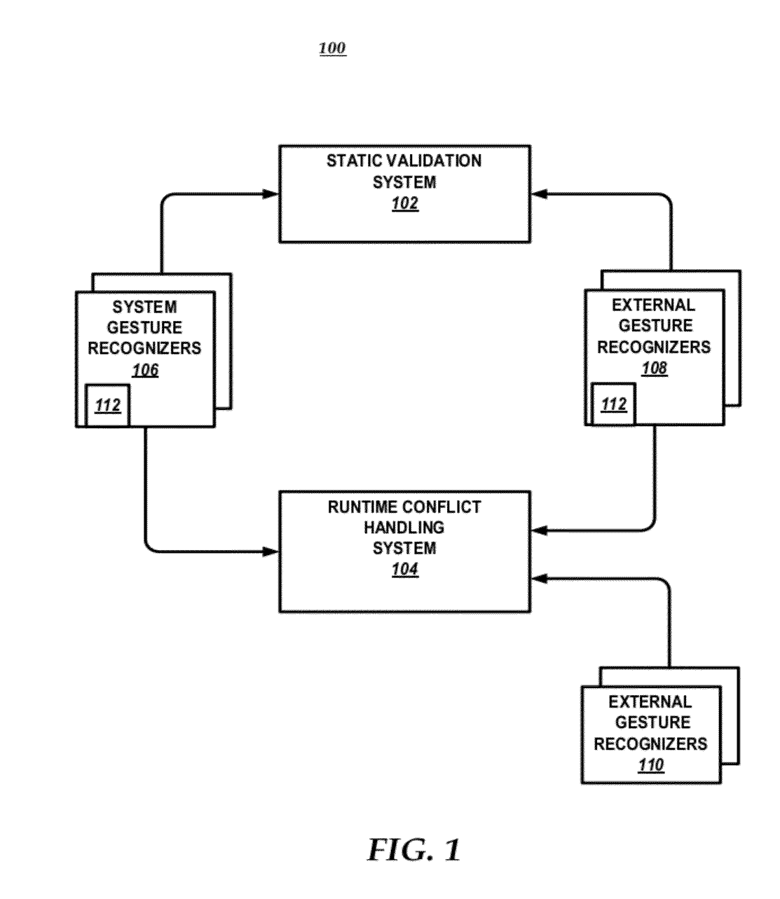

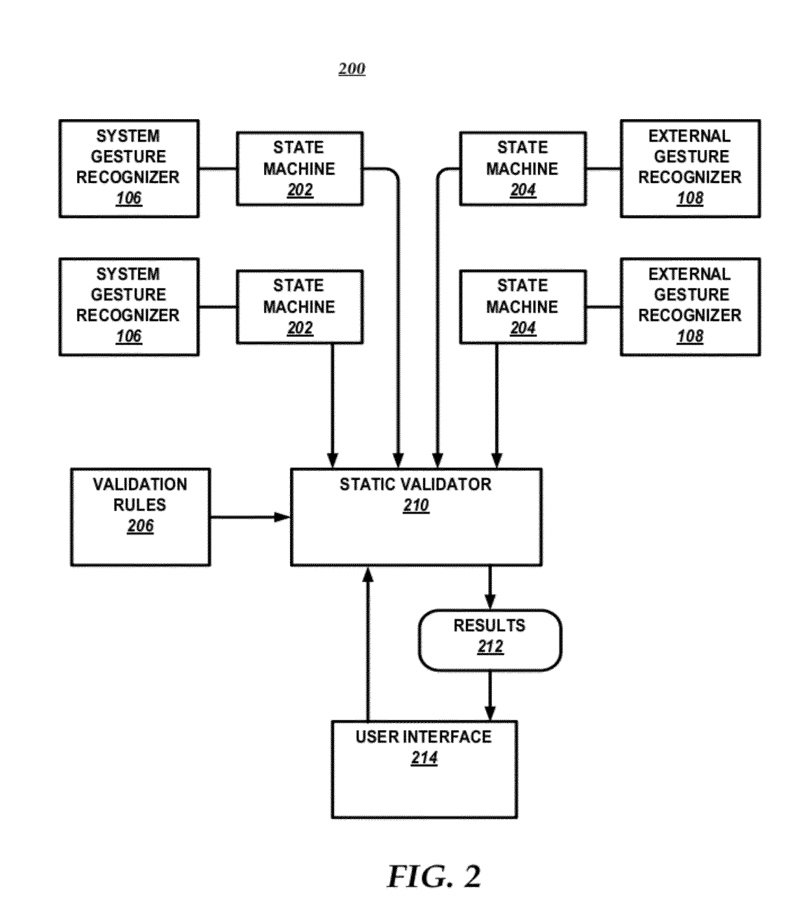

FIG. 1 is a block diagram of an example computer system 100 in which mechanisms described herein may be deployed. The illustrated example system 100 includes static validation system 102, which is a subsystem that may implement mechanisms for statically validating gesture recognizers, statically determining one or more gesture recognition conflicts that may exist, or providing notification of conflicts. FIG. 2 illustrates details of an example static validation system 102.

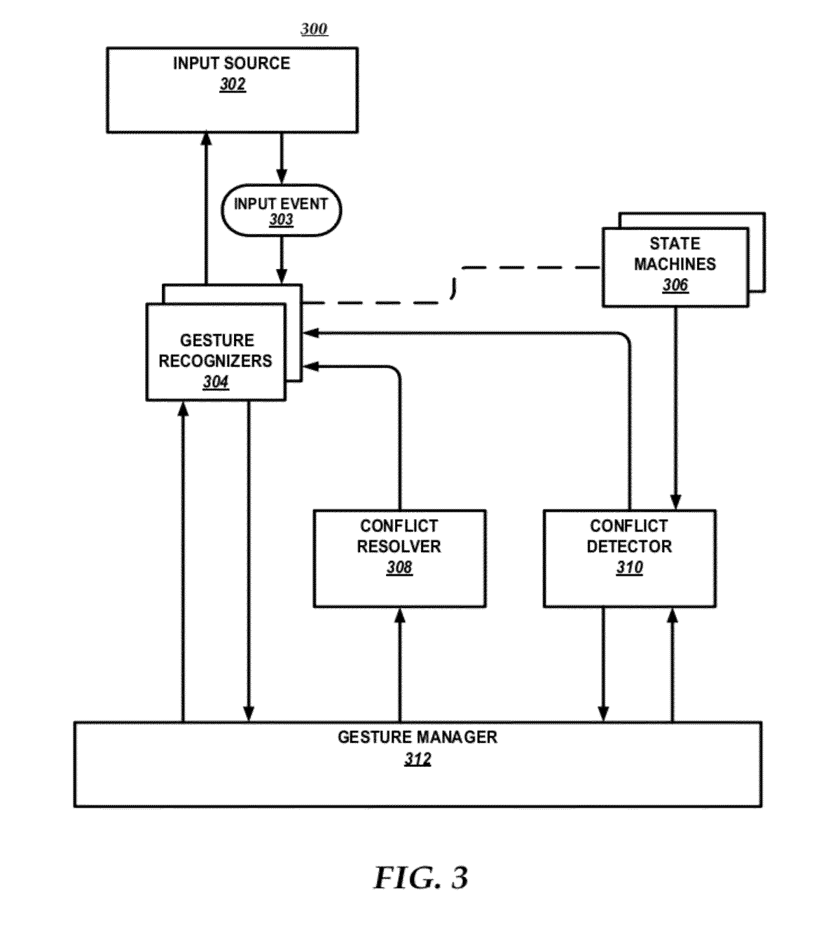

The illustrated example system 100 includes runtime conflict handling system 104, which is a subsystem that may implement mechanisms for detecting gesture recognition conflicts that occur during runtime, determining a resolution of the conflict, or performing actions to facilitate the conflict resolution. FIG. 3 illustrates details of an example runtime conflict handling system.

The illustrated example system 100 includes one or more system gesture recognizers 106 and one or more external gesture recognizers 108 and 110. A gesture recognizer (GR) is a component that includes logic for recognizing a gesture that is received from a user. In one embodiment, a GR is implemented as a self-contained component that is packaged as a binary software module. It may include a state machine 112 representing logic for recognizing a gesture from one or more units of input. Some implementations of a GR may include program instructions that perform actions such as processing received input events, implementing a state machine, responding to entering or exiting a state of the state machine, or other actions.

In some implementations, two or more gesture recognizers may be integrated and combined in a binary software module. As used herein, gesture recognizer refers to a component that recognizes one gesture, though multiple GRs may be integrated, have program code in common, or otherwise combined.

As used herein, each gesture corresponding to a gesture recognizer is considered unique, even though another gesture corresponding to another gesture recognizer may be recognized by an identical sequence of input events. Thus, a gesture is uniquely identified by identification of its corresponding gesture recognizer.

In some implementations, a GR, or a portion thereof, may be implemented as a hardware component. For example, an ASIC may include logic that implements at least a portion of a GR. In some implementations a GR may include a processor and a set of program instructions to perform the actions of gesture recognition.

System gesture recognizers 106 include gesture recognizers that are provided by an entity that provides static validation system 102 or runtime conflict handling system 104. In some embodiments, system gesture recognizers have associated state machines that are available during a process of performing static validation, or during a process of performing runtime conflict handling. External gesture recognizers 108 include gesture recognizers that are provided separately from system gesture recognizers 106. For example, they may be provided by a third party component provider. Some external gesture recognizers may have associated state machines 112 that are available during a process of performing static validation, though some may not include such a state machine. In the illustrated embodiment, each of system gesture recognizers 106 and external gesture recognizers 108 has a corresponding state machine that is available for static validation or runtime conflict detection or handling; external gesture recognizers 110 may omit an available state machine, or have a state machine that is not used by the conflict detection mechanisms described herein. Each of external gesture recognizers 110 may include a state machine to facilitate its actions, though they are not available to access by static validation system 102 or runtime conflict handling system 104.

System 100, or a portion thereof, may be integrated with, or used in conjunction with, a variety of applications. Visio®, by Microsoft Corp., is an example of a drawing application that may be modified to employ system 100, portions thereof, or mechanisms described herein. Various other applications, including operating systems, may also employ these mechanisms.

FIG. 2 is a block diagram of an example computer system 200 in which conflicts among gesture recognizers may be statically analyzed. At least a portion of system 200, or a variation thereof, may be used to implement static validation system 102 of FIG. 1.

As used herein, the terms “static validation,” “static analysis,” and “design time” validation refer to analysis or validation that is performed based on program code without executing the target program code. Though static validation may be performed concurrently with or intermittently with execution of the target program code, static validation does not employ the actions or results of this execution. In some environments, static validation may be included as part of a program “build” that also includes program compilation or other design time actions. Static validation may perform analysis based on source code, native code, intermediate code, or associated data. In some environments, static validation may be performed concurrently with runtime actions. For example, at a time when the system recognizes a new external gesture recognizer, static validation of the new GR may be performed.

The illustrated example embodiment of system 200 includes system gesture recognizers 106 of FIG. 1, as described herein, each having a corresponding state machine 202. State machine 202 may be integrated with system gesture recognizer or packaged separately. Example system 200 includes external gesture recognizers 108, as described herein, each having an associated state machine 204. State machines 202 and 204 may be state machines 112 of FIG. 1.

In one embodiment, static validator 210 is a component having logic to perform actions for statically analyzing gesture recognizers to determine conflicts. In one embodiment, static validator 210 may analyze one or more state machines to determine logic problems other than conflicts. For example, it may recognize an action or condition that is not used, which may be a result of an incorrectly designed state machine. In another example, static validator 210 may recognize a state having multiple transitions triggered by the same input event and condition.

In one implementation, static validator 210 receives each state machine 202 and 204 and performs an analysis based on the state machines to determine if one or more conflicts may result from the concurrent use of the gesture recognizers associated with the state machines. In one embodiment, static validator 210 may include or receive validation rules 206, which include logic for analyzing the state machines. Validation rules 206 may include one or more rules that recognize conflicts or potential logical problems in the design of a state machine. Table 1 includes examples of some rules that may be included in validation rules 206. Various implementations may include any combination of these rules, or other rules not described herein.

TABLE 1
Validation Rules

All actions and conditions included in the state machine are used.
Entry actions are compatible with all incoming transitions.
Two or more outgoing transitions do not have the same trigger event and
condition, including keyboard, mouse, or other modifiers;
Outgoing transitions from a state triggered by a given input event
complement each other or there is an “else” transition.
Each state machine has exactly one initial state.
A state does not have event-triggered transitions and automatic
transitions.
A state does not have reflexive automatic transitions.
Keyboard modifiers and mouse modifiers are consistent.
Actions and conditions on a transition are compatible with the event
triggering the transition.
States without outgoing transitions are final states.
A gesture recognizer has at least one “listening-only” state.
Multiple input events from specified groups (such as MouseDown and
LeftMouseDown) are not used in the same gesture recognizer.
If a state captures the mouse, a transition triggered by the loss of mouse
capture is triggered from the state.

In one embodiment, example system 200 may include user interface (UI) 214, which facilitates interaction with a user. Static validator 210 may provide results 212 to UI 214, which may present them to a developer or other user in the form of a visual display, auditory output, or another manner. Results 212 may include indications of errors or warnings. UI 214 may receive input from a user and provide the input to static validator 210. Examples of input may include commands to ignore a validation error or warning, specifications to indicate how to resolve a conflict, or other commands. Though not illustrated in FIG. 2, some embodiments may include an editor that performs modifications of state machines or adds other data for use in subsequent static validation or execution of gesture recognizers. For example, a developer may specify a resolution of a conflict, such as an indication of the winning gesture recognizer for a conflict. An editor may insert data for use at runtime to resolve the conflict as indicated.

FIG. 3 is a block diagram of an example computer system 300 in which gesture recognizers may be managed during runtime. As used herein, the term “runtime” refers to a phase in which one or more gesture recognizers are active, in that they are receiving or processing input events, or in a state of readiness to receive an input event. It is to be understood that execution of an application may be intermittent in that a processor interleaves processing of the application with other applications, or the application is in a state of readiness waiting for an input event or other event to occur. Runtime may include such intervals, and runtime analysis may be distinguished from static analysis in that gesture recognizer action or states of gesture recognizer execution are used in the analysis.

Example system 300 includes one or more input sources 302 that provide input events 303 or notification of input events, which are considered to be input events herein. In some configurations, input source 302 may include an application that performs intermediate processing to filter, process, modify, or create input events for receipt by gesture recognizers. For example, in one configuration, input source 302 may include an image processor that receives and processes images to detect or determine input events 303.

Example system 300 includes one or more gesture recognizers 304, each of which may be system gesture recognizer 106 or external gesture recognizer 108 or 110. Gesture recognizers 304 may subscribe to one or more event streams from input source 302, and receive input events from input source 302.

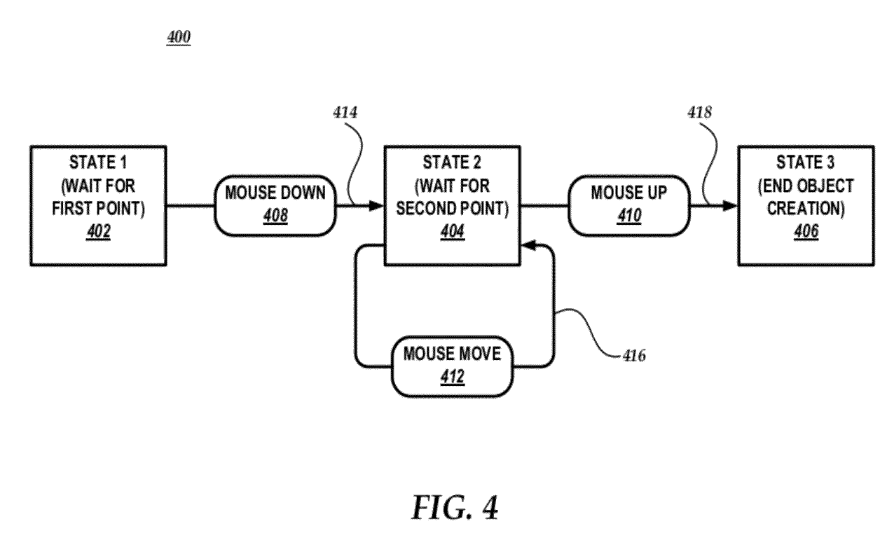

State machines 306 may include one or more of state machine 202 or 204 of FIG. 2. Each gesture recognizer 304 may use a corresponding state machine 306 to process input events 303 as part of a process of recognizing a gesture. FIG. 4 illustrates an example state machine.

Example system 300 includes gesture manager 312, conflict detector 310 and conflict resolver 308. In one implementation, gesture manager 312 may discover and activate each gesture recognizer 304 as the gesture recognizer initializes, becomes active, or otherwise begins processing as part of system 300.

In one implementation, each gesture recognizer 304 may, as part of its gesture recognition processing, send to gesture manager 312 a request to access or control a resource or to perform an action. A cursor corresponding to a mouse is an example of such a resource. A gesture recognizer may include logic to modify the appearance or behavior of a cursor resource. It may therefore request control of the cursor resource. The request may serve as a notification to gesture manager that the requesting gesture recognizer is in a state of recognizing a gesture.

In response to a resource or action request, gesture manager 312 may determine whether to allow the requesting gesture recognizer to access or control a requested resource, or to perform another action. In one embodiment, this determination may include forwarding the request to conflict detector 310. Conflict detector 310, in response to receiving a resource request, may determine whether to enable the requesting gesture recognizer as requested. Conflict detector 310 may respond to gesture manager 312 with an indication of whether the request is to be allowed. A description of conflict detection by conflict detector 310 is provided herein. In some embodiments, conflict detector 310 may use one or more state machines 306 associated with gesture recognizers to detect conflicts. In some embodiments conflict detector 310 performs conflict detection without the use of state machines 306.

In one embodiment, in response to a determination that a conflict for a resource or an action exists, gesture manager 312 may command conflict resolver 308 to perform actions to resolve the conflict. In some embodiments, these actions may include one or more of determining a “winning” gesture recognizer among two or more conflicting gesture recognizers, instructing one or more “losing” gesture recognizers that they are to restart gesture recognition with respect to a current gesture, or enabling the winning gesture recognizer to proceed with its requested action or resource. A more detailed description of gesture conflict resolution is provided herein.

In one implementation, each of conflict detector 310 and conflict resolver 308 may be a plug-in application that integrates with a parent gesture manager 312. In various implementations, conflict detector 310 or conflict resolver 308 may be integrated with gesture manager in a variety of ways. In some embodiments, multiple conflict detectors or multiple conflict resolvers may be employed concurrently or interchanged based on system configuration.

FIG. 4 is a block diagram illustrating an example state machine 400 that may be used to implement a system gesture recognizer 106 or external gesture recognizer 108 or 110. Example state machine 400 may be any of state machines 202, 204, or 306 described herein. Example state machine 400 may be used to perform actions of creating a line object in a diagramming application. State machine 400 includes state 1 402, state 2 404, and state 3 406, input events mouse down event 408, mouse move event 412, and mouse up event 410, and transitions 414, 416, and 418.

As illustrated, state 1 402 is an initial state of waiting for a first input event, specifically mouse down event 408. In response to this event, state machine 400, following transition 414, transitions to state 2 404, which is a state of waiting for a second point to be set. When in state 2 404, a mouse move event 412 causes a transition 416 back to state 2 404. A mouse up event 410 when in state 2 404 causes a transition 418 to state 3 406, which is a state of ending an object creation. Though not illustrated, at each transition, various actions may be performed, such as drawing a line segment. It is to be noted that a variety of gesture recognizers may employ a similar state machine, each gesture recognizer having its own set of actions corresponding to state transitions. For example, gestures and gesture recognizers with a similar state machine may be used for drawing different types of objects, creating a selection rectangle, drawing a selection lasso, moving a drawing object, or the like, though the actions associated with each transition may differ.

A state machine may have one or more representations. A state machine may have a static representation in the form of source code or data, such that the state machine may be available for static analysis and validation, such as described herein. The state machine may also be embodied in executable instructions, and may be used to implement a gesture recognizer. State machine 400 may describe a static representation or an executable embodiment.

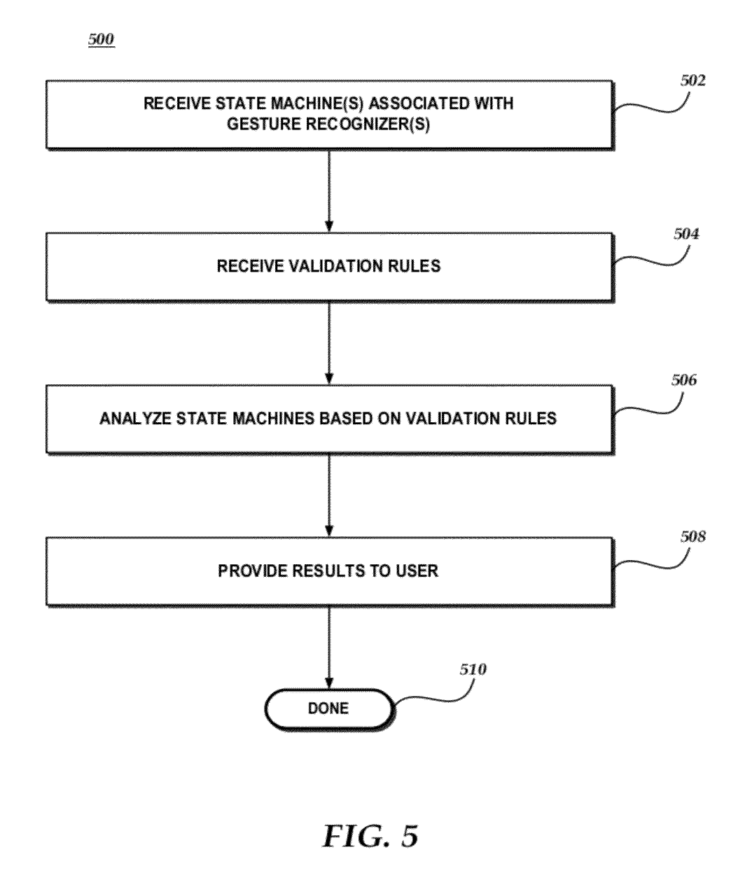

FIG. 5 is a flow diagram illustrating an example embodiment of a process 500 for performing a static validation of a gesture recognizer. Process 500, or a portion thereof, may be performed by various embodiments of system 200 or a variation thereof. Components of system 200 are used as examples of an implementation herein, though in various embodiments, the correspondence of process actions and components may vary. The illustrated portions of process 500 may be initiated at block 502, where one or more state machines may be received, each state machine having a corresponding gesture recognizer. In various implementations, a state machine may have one or more representations. For example, there may be a source code representation or a binary representation that static validator 210 understands.

The process may flow to block 504, where a set of validation rules 206 is received. In some implementations, a set of validation rules may be previously integrated or built into static validator 210. In some implementations, one or more sets of validation rules may be packaged separately and used by static validator 210. Validation rules may have varying representations, such as source code, binary representations, intermediate or machine instructions, interpretable commands, data, or a combination thereof.

The process may flow to block 506, where an analysis of the received one or more state machines is performed, based on the validation rules. The process may flow to block 508, where results of the validation analysis may be provided to a developer or other user. As discussed herein, user interface 214 may receive results 212 and provide them to a user.

In response to receiving validation results, a developer or other user may perform one or more actions, such as modifying a state machine, removing a gesture recognizer, specifying how a conflict is to be resolved, or another action, or perform no action in response.

The process may flow to done block 510, and exit or return to a calling program.

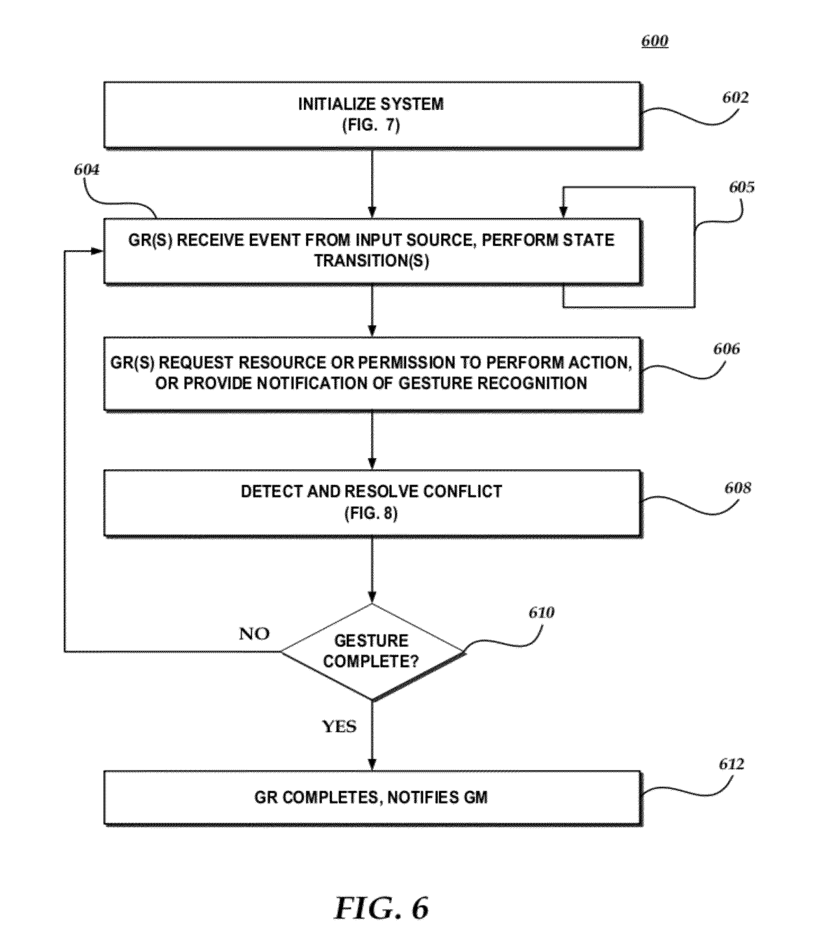

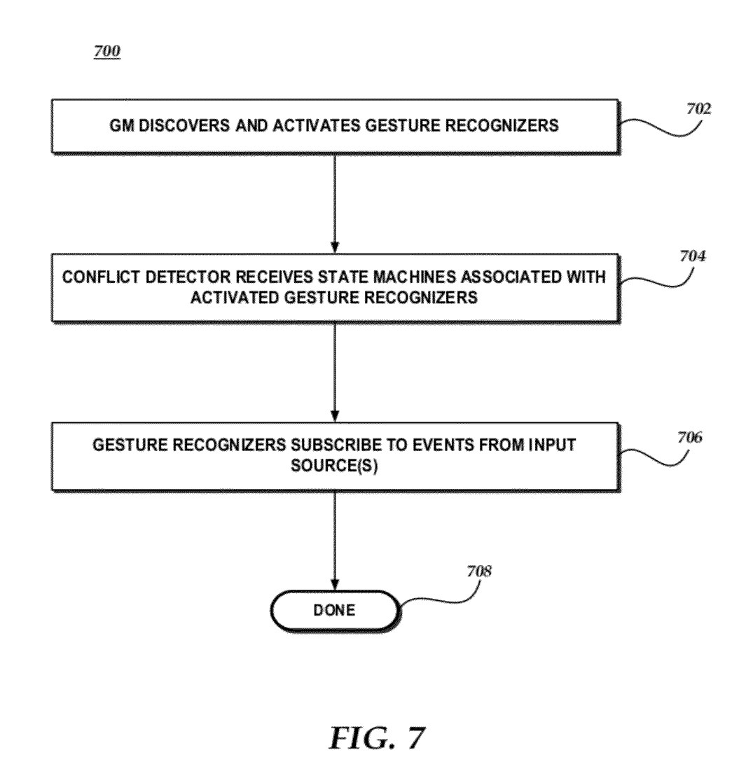

FIG. 6 is a flow diagram illustrating an example embodiment of a process 600 for managing gesture recognizers during runtime. Process 600, or a portion thereof, including illustrated sub processes, may be performed by various embodiments of system 300 or a variation thereof. Components of system 300 are used as examples of an implementation herein, though in various embodiments, the correspondence of process actions and components may vary. The illustrated portions of process 600 may be initiated at block 602, where the system is initialized. FIG. 7 provides an example of actions that may be performed to implement block 602.

The process may flow to block 604, where one or more gesture recognizers 304 receive an input event from input source 302. Each gesture recognizer may selectively perform a state transition in response to the input event. As illustrated by arrow 605, the actions of block 604 may be repeated zero or more times.

A gesture recognizer may selectively issue a request for a resource or permission to perform an action, as part of an action associated with a state transition. The process may flow to block 606, where a request is issued. In the example system 300, this request is issued to gesture manager 312. In some embodiments, the gesture recognizer may notify the gesture manager that it has at least partially recognized a gesture, without including a request for an action or a resource.

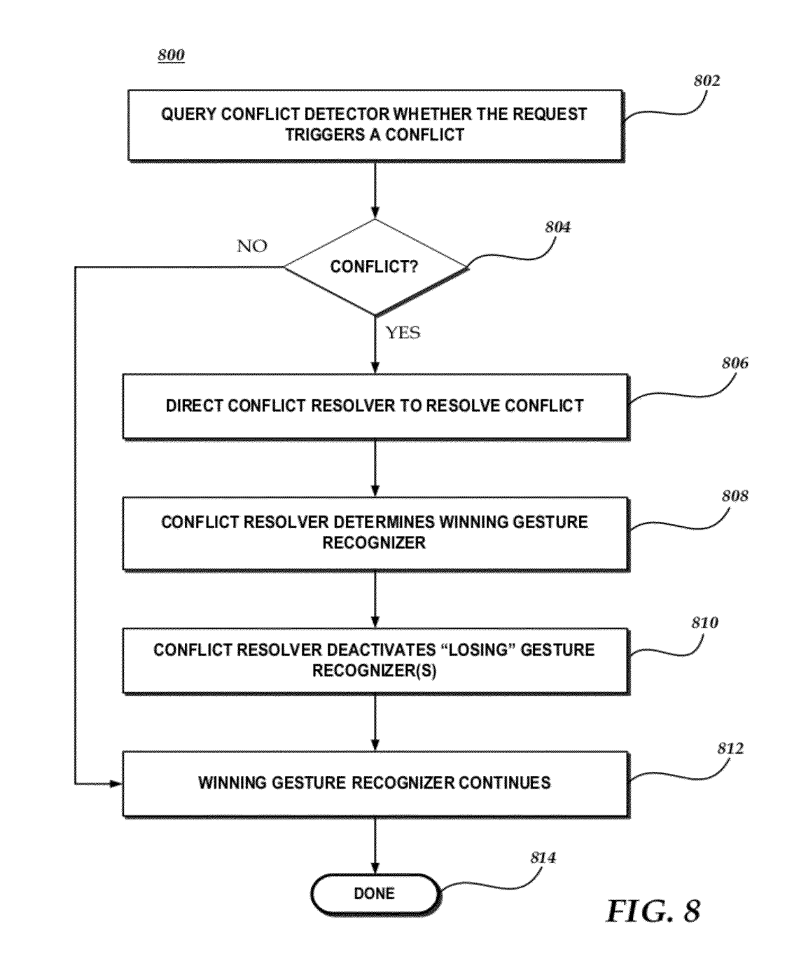

The process may flow to block 608, where a conflict, if it exists, is detected and resolved. FIG. 8 provides an example of actions that may be performed to implement block 608. As described herein, one possible resolution is to temporarily deactivate one or more gesture recognizers that are associated with the current conflict. In one implementation, the actions of block 608 may result in one active gesture recognizer that is processing a gesture, referred to as the “current gesture.”

The process may flow to decision block 610, where a determination is made of whether the current gesture, or an action associated with a gesture, is complete. In one embodiment, a gesture recognizer notifies the gesture manager when it has completed a gesture recognition or an action associated with the gesture recognition. If it is not complete, the process may flow back to block 604, and continue to receive one or more additional input events. If the gesture is complete, the process may flow to block 612, where the active gesture recognizer may complete its actions. In one implementation, the gesture recognizer may notify gesture manager 312 that its actions associated with the gesture are complete.

The process may exit or return to a calling program. In some embodiments, process 600, or a portion thereof, may be repeatedly performed until terminated by a user action, system command, or program logic. In some iterations of process 600, some or all of the initialization actions of block 602 may be omitted.

FIG. 7 is a flow diagram illustrating an example embodiment of a process 700 for initializing a gesture management system. Process 700, or a portion thereof, may be used to implement at least a portion of the actions of block 602, of FIG. 6. The illustrated portions of process 700 may be initiated at block 702, where gesture manager 312 discovers and activates each gesture recognizer 304. Discovery of a gesture recognizer may be initiated by the gesture recognizer or by gesture manager 312.

The process may flow to block 704, where conflict detector 310 receives one or more state machines associated with activated gesture recognizers. In some configurations, only a portion of active gesture recognizers provide state machines to conflict detector 310. In some embodiments, the actions of block 704 may be omitted, and the use of state machines to perform conflict detection may not occur.

The process may flow to block 706, where each gesture recognizer subscribes to input events from input source 302. In some configurations, the system may include multiple input sources 302. Each gesture recognizer may subscribe to all, or a portion of, the available input sources.

The process may flow to done block 708 and exit, or return to a calling program, such as process 600. As discussed herein, process 700, or portions thereof, may be performed multiple times. For example, each time an additional gesture recognizer is added to an ongoing system, gesture manager 312 may discover the additional gesture recognizer and activate it; the additional gesture recognizer may subscribe to input events as described in block 706.

FIG. 8 is a flow diagram illustrating an example embodiment of a process 800 for handling gesture conflicts during runtime. Process 800, or a portion thereof, may be used to implement at least a portion of the actions of block 608, of FIG. 6. As illustrated in FIG. 6, process 800 may be performed in response to receiving a request for a resource, permission to perform an action, or other notification from a gesture recognizer.

The illustrated portions of process 800 may be initiated at block 802, where gesture manager 312 may forward a request to conflict detector 310 and queries the conflict detector as to whether the request triggers a conflict. The process may flow to decision block 804, where a determination is made of whether a conflict exists.

At decision block 804, conflict detector 310 may evaluate whether a current input event may cause a conflict. In one implementation, this determination may include querying each active gesture recognizer, other than the requesting gesture recognizer, as to whether the current input event may result in a state transition that would conflict with the requesting gesture recognizer. If a response from a gesture recognizer indicates a conflict, conflict detector 310 may thus determine that a conflict exists, and the determination of decision block 804 is affirmative. If no such conflict is known, the determination of decision block 804 may be negative. In some implementations, conflict detector 310 may monitor requests for resources, and determine whether more than one gesture recognizer requests the same resource in response to the same input event.

In one implementation, the actions of decision block 804 may include analyzing known state machines to determine whether a conflict exists. In some implementations, conflict detector may omit querying any conflict detector for which it has a state machine to analyze. For example, it may be able to determine based on a state machine, that the associated gesture recognizer will not perform a state transition in response to the current input event, and therefore omit querying the gesture recognizer.

If, at decision block 804, a conflict is not determined, the process may flow to block 812, where the requesting gesture recognizer continues. In this case, the requesting gesture recognizer is the “winning” gesture recognizer by default, in that there is no conflict.

If, at decision block 804, a conflict is determined, the process may flow to block 806, where gesture manager 312 directs conflict resolver 308 to resolve the conflict. The process may flow to block 808, where conflict resolver 308 determines a gesture recognizer that is to be enabled to continue with actions related to the current gesture. This determined gesture recognizer becomes the winning gesture recognizer. The remaining gesture recognizers, or at least those that may be in a state of recognizing a gesture based on the current input event, are referred to as the losing gesture recognizers. In some configurations, a gesture recognizer may have previously been enabled to control a resource or perform an action, and process 800 is triggered by another gesture recognizer that is attempting to control the same resource or perform a conflicting action. In this situation, the gesture recognizer that already has control may be determined to be the winning gesture recognizer.

In some embodiments, a conflict resolver may be configured with rules, data, or other specifications that indicate how to resolve a gesture recognizer conflict. For example, a specification may indicate a priority among two or more gesture recognizers that applies to all, or a subset, of gestures. Some rules may indicate that a conflict is to be resolved based on a previous user action, a system configuration, or another factor. Multiple conflict resolution factors may be weighted to determine a resolution.

The process may flow to block 810, where conflict resolver 308 deactivates the losing gesture recognizers with respect to a current gesture that each one is processing. In one implementation, deactivating includes sending the gesture recognizer a message or signal indicating that it is to cease such processing, though it remains ready to recognize a future gesture. In one implementation, deactivating a gesture recognizer may be performed by withholding a permission to proceed with its current gesture recognition.

In some embodiments, a developer or other user may specify a conflict resolution at runtime, for example when prompted by a UI. The user may indicate the winning gesture recognizer for a particular conflict or set of conflicts. The system may store this indication as metadata for subsequent use in recognizing another gesture. The metadata may be used in response to a subsequent conflict or to avoid a subsequent conflict.

The process may flow to block 812, where the winning gesture recognizer is enabled to continue. In one embodiment, enabling the winning gesture recognizer may be performed by not deactivating it, so that its default action is to continue processing. In one embodiment, the winning gesture recognizer may be sent a signal or message indicating that it is to proceed. A response to a resource or action request may serve as the signal that the winning gesture recognizer may proceed.

The process may flow to done block 814, and exit or return to a calling program, such as process 600.

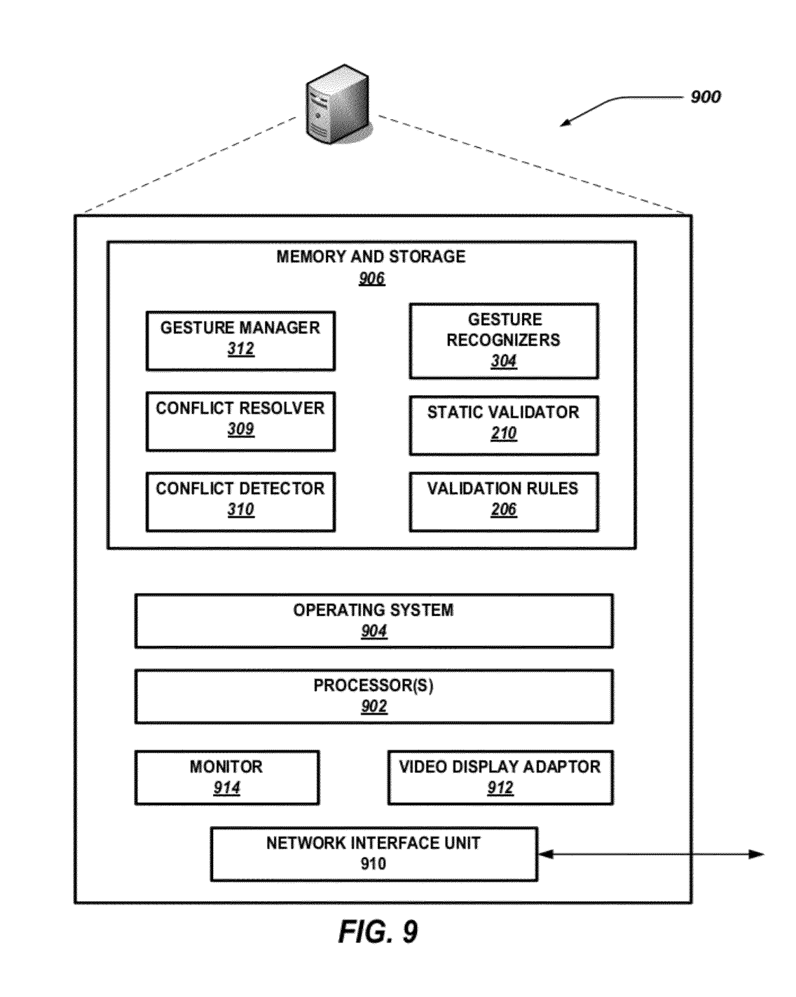

FIG. 9 is a block diagram showing one embodiment of a computing device 900, illustrating selected components of a computing device that may be used to implement mechanisms described herein, including system 100 and processes 500, 600, 700, or 800. Computing device 900 may include many more components than those shown, or may include less than all of those illustrated. Computing device 900 may be a standalone computing device or part of an integrated system, such as a blade in a chassis with one or more blades. Though the components of computing device 900 are illustrated as discrete components, any one or more of them may be combined or integrated into an integrated circuit, such as an ASIC.

As illustrated, computing device 900 includes one or more processors 902, which perform actions to execute instructions of various computer programs. In one configuration, each processor 902 may include one or more central processing units, one or more processor cores, one or more ASICs, cache memory, or other hardware processing components and related program logic. As illustrated, computing device 900 includes an operating system 904. Operating system 904 may be a general purpose or special purpose operating system. The Windows® family of operating systems, by Microsoft Corporation, of Redmond, Wash., includes examples of operating systems that may execute on computing device 900.

Memory and storage 906 may include one or more of a variety of types of non-transitory computer storage media, including volatile or non-volatile memory, RAM, ROM, solid-state memory, disk drives, optical storage, or any other medium that can be used to store digital information.

Memory and storage 906 may store one or more components described herein or other components. In one embodiment, memory and storage 906 stores gesture manager 312, conflict resolver 308, conflict detector 310, one or more gesture recognizers 304, static validator 210, and validation rules 206. In various embodiments, one or more of these components may be omitted from memory and storage 906. In some embodiments, at least a portion of one or more components may be implemented in a hardware component, such as an ASIC. In various configurations, multiple components implementing the functions or including the data of these components may be distributed among multiple computing devices. Communication among various distributed components may be performed over a variety of wired or wireless communications mechanisms.

Any one or more of the components illustrated as stored in memory and storage 906 may be moved to different locations in RAM, non-volatile memory, or between RAM and non-volatile memory by operating system 904 or other components. In some configurations, these components may be distributed among one or more computing devices.

Computing device 900 may include a video display adapter 912 that facilitates display of graph diagrams or other information to a user. Though not illustrated in FIG. 9, computing device 900 may include a basic input/output system (BIOS), and associated components. Computing device 900 may also include a network interface unit 910 for communicating with a network. Software components, such as those stored in memory and storage 906, may be received via transitory media and network interface unit 910. Computing device 900 may include one or more display monitors 914. Embodiments of computing device 900 may include one or more input devices 916, such as a keyboard, pointing device, touch screen, keypad, audio component, microphone, voice recognition component, or other input/output mechanisms.

It will be understood that each block of the flowchart illustration of FIGS. 5-8, and combinations of blocks in the flowchart illustration, can be implemented by software instructions. These program instructions may be provided to a processor to produce a machine, such that the instructions, which execute on the processor, create means for implementing the actions specified in the flowchart block or blocks. The software instructions may be executed by a processor to provide steps for implementing the actions specified in the flowchart block or blocks. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A computer-based method of recognizing a gesture in a system including a plurality of gesture recognizers, the method comprising:
a) receiving, from a first gesture recognizer of the plurality of gesture recognizers, a notification that the first gesture recognizer has at least partially recognized a gesture based on an input event;
b) determining whether a conflict exists by determining whether one or more other gesture recognizers have at least partially recognized another gesture based on the input event;
c) if a conflict exists, performing conflict resolution actions comprising:
i.) determining a winning gesture recognizer from among the first gesture recognizer and the one or more other gesture recognizers; and
ii.) enabling the winning gesture recognizer to proceed with processing of its corresponding gesture.

2. The computer-based method of claim 1, wherein enabling the winning gesture recognizer to proceed with processing comprises deactivating at least one gesture recognizer other than the winning gesture recognizer.

3. The computer-based method of claim 1, wherein each of the gesture recognizers is a self-contained software component executing on a processor, the method further comprising discovering, at runtime, one or more of the gesture recognizers.

4. The computer-based method of claim 1, receiving the notification comprises receiving a request to access a resource or to perform an action.

5. The computer-based method of claim 1, at least one of the gesture recognizers having a corresponding state machine, determining whether the conflict exists comprises employing one or more state machines corresponding to one or more gesture recognizers to determine whether the conflict exists.

6. The computer-based method of claim 1, at least one of the gesture recognizers having a corresponding state machine, further comprising performing a static validation of the at least one of the gesture recognizers based on the corresponding state machine.

7. The computer-based method of claim 1, further comprising discovering a second gesture recognizer at runtime, the second gesture recognizer being one of the one or more other gesture recognizers.

8. The computer-based method of claim 1, determining the winning gesture comprising:
a) receiving, from a user, specifications for resolving the conflict; and
b) determining the winning gesture recognizer based on the specification from the user;
the method further comprising storing the specifications as metadata for subsequent use recognizing another gesture.

9. A computer-readable storage medium comprising computer program instructions facilitating recognition of one or more gestures, the program instructions executable by one or more processors to perform actions including:
a) receiving from a gesture recognizer a notification of at least partial recognition of a gesture of the one or more gestures based on an input event;
b) determining whether a conflict exists between the gesture recognizer and one or more other gesture recognizers; and
c) if a conflict exists, resolving the conflict by determining a winning gesture recognizer from among the gesture recognizer and the one or more other gesture recognizers.

10. The computer-readable storage medium of claim 9, resolving the conflict further comprising performing actions to deactivate at least one gesture recognizer other than the winning gesture recognizer.

11. The computer-readable storage medium of claim 9, resolving the conflict further comprising:
a) receiving, from a user, specifications for resolving the conflict;
b) determining the winning gesture recognizer based on the specification from the user.

12. The computer-readable storage medium of claim 9, further comprising a means for enabling a new gesture recognizer to be added to a system during runtime and to manage conflicts related to the new gesture recognizer, the enabling means comprising the one or more instructions and the processor.

13. The computer-readable storage medium of claim 9, further comprising a validation means for performing a static validation of one or more gesture recognizers, the validation means comprising the one or more instructions and the processor.

14. A computer-based system for facilitating gesture recognition, comprising:
a) a processor;
b) a gesture manager that interacts with one or more gesture recognizers, each gesture recognizer including logic to receive one or more input events and recognize a gesture corresponding to the gesture recognizer based on the received input events;
c) a conflict detector that receives a notification indicating that a first gesture recognizer of the one or more gesture recognizers recognizes at least a portion of the gesture corresponding to the first gesture recognizer, the conflict detector including logic to determine a conflict between the first gesture recognizer and a second gesture recognizer; and
d) a conflict resolver that resolves a conflict by determining a winning gesture recognizer and enabling the winning gesture recognizer to perform processing associated with a gesture corresponding to the winning gesture recognizer.

15. The computer-based system of claim 14, further comprising a static validator that determines a conflict between the first gesture recognizer and a second gesture recognizer based on a first state machine corresponding to the first gesture recognizer and a second state machine corresponding to the second gesture recognizer.

16. The computer-based system of claim 14, the conflict detector configured to determine the conflict based on a respective state machine corresponding to each of the first gesture recognizer and the second gesture recognizer.

17. The computer-based system of claim 14, further comprising a set of gesture recognizers, each gesture recognizer having a corresponding state machine.

18. The computer-based system of claim 14, the gesture recognizer including program instructions to control access to a computer resource by the one or more gesture recognizers.

19. The computer-based system of claim 14, the conflict detector including logic to query the second gesture recognizer to determine whether a current input event triggers a conflict with the first gesture recognizer.

20. The computer-based system of claim 14, the conflict detector comprising means for determining a conflict based on a state machine associated with each gesture recognizer.
